(19) United States
(12) Patent Application Publication
(10) Pub. No.: US 2024/0257401 A1
(43) Pub. Date: Aug. 1, 2024

(54) Systems and Methods for Improving Compression of Normal Maps

(71) Applicant: Six Impossible Things Before Breakfast Limited, Dublin (IE)

(72) Inventors: Sherry IGNATCHENKO, Weidling (AT); Dmytro IVANCHYKHIN, Kiev (UA)

(73) Assignee: Six Impossible Things Before Breakfast Limited, Dublin (IE)

(21) Appl. No.: 18/425,130

(22) Filed: Jan. 29, 2024

Related U.S. Application Data
(60) Provisional application No. 63/482,287, filed on Jan. 30, 2023.

(51) Int. Cl. G06T 9/00; G06T 19/20

(52) U.S. Cl. CPC G06T 9/00; G06T 19/20; G06T 2219/2012

(57) ABSTRACT

The systems and methods described herein provide improved techniques for compressing texture maps used to render three-dimensional models in computer-generated graphics. In various implementations, the systems and methods described herein may be used to compress normal maps or similar texture maps used to render three-dimensional models. When compressing an image, a conversion may be applied to the image. For example, an integrating conversion or a color-space conversion may be applied to the image. Quantization may then be applied to the resulting integrated or color-converted image. Using an existing compression method, the resulting image may then be compressed before it is transferred and/or stored. When decompressing the image, an existing decompression method may be used that is complementary to the compression method used to compress the compressed image. The resulting decompressed integrated or color-converted image may then be converted back into the original image as described herein.

### RELATED APPLICATIONS

This application claims priority to U.S. Provisional Application No. 63/482,287, entitled “Method for In-Transit Compression of Normal Maps,” filed on Jan. 30, 2023, the content of which is hereby incorporated herein by reference in its entirety.

### FIELD OF THE DISCLOSURE

The systems and methods described herein relate to improvements to the compression of texture maps used to render three-dimensional models in computer-generated graphics.

### BACKGROUND

In computer graphics, textures are frequently used to render the surface of a computer-generated graphic or three-dimensional model. These computer-generated graphics or three-dimensional models may be rendered using meshes consisting of hundreds or thousands of triangles (or other polygons). Textures may be mapped to these flat triangles to add detail, surface texture, or color to the computer-generated graphic or three-dimensional model. In certain circumstances, it may be easy to see these underlying flat triangles. For example, when viewed in a lit scene, the lighting may not take into account irregularities of a texture (e.g., small cracks, holes, or other surface imperfections). One widely used technique for addressing this deficiency in order to enhance the realism of three-dimensional computer-generated graphics is “normal mapping.”

Normal mapping is a texture mapping technique that may be used to improve the appearance of surface irregularities on a three-dimensional model in a lit scene without requiring the addition of more polygons. When a three-dimensional model is exposed to a light source, the light is rendered on the surface of the three-dimensional model based on the shape of the object, which is determined by the object's perpendicular normal vector. Rather than using a per-surface normal that is the same for each fragment, normal mapping uses a per-fragment normal that is different for each fragment. The use of per-fragment normal vectors may give the surface of the three-dimensional model a boost in detail by tricking the lighting into believing the surface consists of many planes as opposed to one.

Unsurprisingly, this boost in detail comes with additional complications, as normal maps are more difficult to compress. As used herein, a “normal map” is a kind of texture map that allows a developer to add surface detail to a model that will catch the light using normal mapping. Normal maps comprise normal vectors (i.e., vectors normalized in 3D space) defined at each “pixel” of the normal map. Normal maps are commonly stored as regular RGB images in which the RGB components correspond to the X, Y, and Z coordinates, respectively, of the surface normal. Using conventional techniques for compressing normal maps (e.g., for downloading via the Internet) suffer from various drawbacks. Current methods for normal map compression (such as DXT5 nm compression) on graphics processing units (or GPUs) provide only very limited compression. Meanwhile, general image compression methods (such as those associated with the JPEG or AVIF file format) tend to produce too many artifacts, causing the rendered 3D model to look much worse. Similar problems also exist with conventional techniques for compressing other types of texture maps. As such, there is a need in the art for improved technique(s) for compressing texture maps (such as normal maps or other types of texture maps) that allows the texture maps to be compressed to smaller sizes while still producing renderings of reasonable quality when used to render a three-dimensional model.

### SUMMARY OF THE DISCLOSURE

This disclosure relates to systems and methods for compressing texture maps used to render three-dimensional models in computer-generated graphics. In various implementations, the systems and methods described herein may be used to compress normal maps or similar texture maps (which may be referred to herein as “images”) to be used to render three-dimensional models. When compressing an image, a conversion may first be applied to the image. For example, an integrating conversion or a color-space conversion may be applied to the image. Quantization may then be applied to the resulting integrated or color-converted image. Using an existing compression method, the resulting image may then be compressed before it is transferred and/or stored. When decompressing the compressed image, an existing decompression method may be used that is complementary to the compression method used to compress the compressed image. The resulting decompressed integrated or color-converted image may then be converted back into the original image using one or more of the techniques described herein.

According to one aspect of the invention, the systems and methods described herein may compress texture maps (such as normal maps) using an integrating conversion. In various implementations, an integrating conversion may be applied to a normal map. Applying an integrating conversion to the normal map may produce an “integrated image,” in which each of the pixels in the normal map may be represented as floating-point numbers. In some implementations, the integrating conversion may involve optimizing per-pixel difference between an original normal map and a normal map obtained when a pre-defined “differential operator” is applied to this point. In some implementations, the differential operator may be calculated based on a current point and two adjacent points (e.g., one adjacent point in the x-direction and one adjacent point in the y-direction). Quantization may be applied to the integrated image to produce an RGB integrated image of the normal map. The resultant map obtained after applying quantization may comprise a height map of the initial normal map. The RGB integrated image may then be compressed using an existing compression method. For example, the RGB integrated image may be compressed using a method associated with the AVIF or JPEG XL file formats. The compressed integrated image may then be stored and/or transferred.

According to another aspect of the invention, the systems and methods described herein may decompress texture maps (such as normal maps) that have been compressed using an integrated conversion. In various implementations, a compressed integrated image may be decompressed using an existing compression method complementary (or associated with) a compression method used to compress the integrated image. As noted above, the compressed integrated image may comprise a compressed RGB integrated image of a normal map. The decompressed RGB integrated image of the normal map may then be converted into a floating-point representation of the image. Converting the decompressed image into a floating-point representation may comprise multiplying each point by a scale parameter. Each pixel may then be assigned a value taken from a value map generated when quantization is applied to the integrated image of the normal map prior to compression. In order to remove systemic shifts in the converted image when compared to the original “integrated” image, a differential conversion may be applied to the floating-point representation of the image. Various techniques described herein may be used to apply a differential conversion. The image obtained after converting the image and applying a differential conversion may comprise the decompressed normal map to which an integrating conversion was originally applied.

According to another aspect of the invention, the systems and methods described herein may compress texture maps using a color space conversion. In various implementations, a color space conversion may be applied to an image. In some implementations, the image may comprise a normal map or one or more other physical based rendering (PBR) maps. The color space conversion may be applied to each pixel in the image. The color space conversion may include multiplication of RGB values of the pixel to a 3×3 “color conversion” matrix, gamma correction, and/or one or more other processes. Quantization may be applied to the resultant color-converted image to produce an RGB color-converted image. The RGB color-converted image may then be compressed using an existing compression method. For example, the RGB integrated image may be compressed using a method associated with the AVIF or JPEG XL file formats. The compressed color-converted image may then be stored and/or transferred.

According to another aspect of the invention, the systems and methods described herein may decompress texture maps that have been compressed using a color space conversion. In various implementations, a compressed color-converted image may be decompressed using an existing compression method complementary (or associated with) a compression method used to compress the color-converted image. An inverse color space conversion may then be performed on the decompressed color-converted image. The inverse color space conversion may be performed using a color conversion matrix that was used to apply the color space conversion to the initial image prior to compression. The image obtained after performing the inverse color space conversion may comprise the decompressed image to which the color space conversion was originally applied.

These and other objects, features, and characteristics of the systems and/or methods disclosed herein, as well as the methods of operation and functions of the related elements of structure and the combination thereof, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIG. 1 depicts a block diagram of an example of a system configured to compress texture maps, according to one or more aspects described herein;

FIG. 2 depicts a flow diagram of an example of a method for compressing texture maps using an integrating conversion, according to one or more aspects described herein;

FIG. 3 depicts a flow diagram of an example of a method for decompressing integrated images using differential conversion, according to one or more aspects described herein;

FIG. 4 depicts a flow diagram of an example of a method for compressing texture maps using a color space conversion, according to one or more aspects described herein; and

FIG. 5 depicts a flow diagram of an example of a method for decompressing color-converted images using inverse color space conversion, according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and case of illustration, these drawings are not necessarily drawn to scale.

### DETAILED DESCRIPTION

Certain illustrative aspects of the systems and methods according to the present invention are described herein in connection with the following description and the accompanying figures. These aspects are indicative, however, of but a few of the various ways in which the principles of the invention may be employed and the present invention is intended to include all such aspects and their equivalents. Other advantages and novel features of the invention may become apparent from the following detailed description when considered in conjunction with the figures.

In the following detailed description, numerous specific details are set forth in order to provide a thorough understanding of the invention. In other instances, well known structures, interfaces, and processes have not been shown in detail in order not to unnecessarily obscure the invention. However, it will be apparent to one of ordinary skill in the art that those specific details disclosed herein need not be used to practice the invention and do not represent a limitation on the scope of the invention, except as recited in the claims. It is intended that no part of this specification be construed to effect a disavowal of any part of the full scope of the invention. Although certain embodiments of the present disclosure are described, these embodiments likewise are not intended to limit the full scope of the invention.

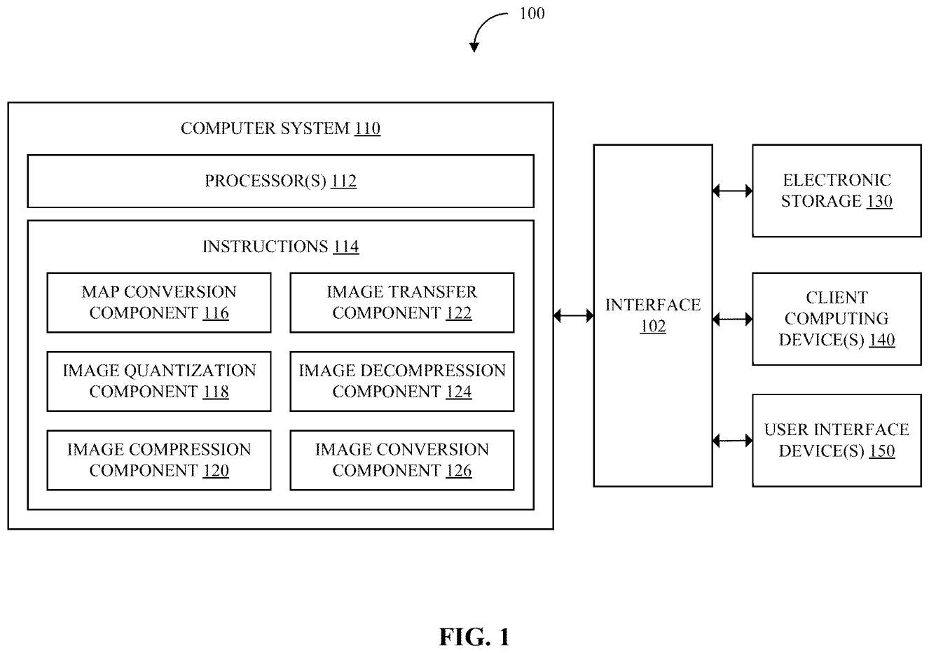

FIG. 1 illustrates an example of a system 100 for compressing images, according to one or more aspects described herein. In various implementations, system 100 may include one or more of interface 102, a computer system 110, electronic storage 130, client computing device(s) 140, and/or other components. In various implementations, computer system 110 may include one or more physical computer processors 112 (also interchangeably referred to herein as processor(s) 112, processor 112, or processors 112 for convenience), computer readable instructions 114, and/or one or more other components. In some implementations, system 100 may include one or more external resources, such as sources of information outside of system 100, external entities participating with system 100, and/or other resources. In various implementations, system 100 may be configured to receive input from or otherwise interact with one or more users via one or more client computing device(s) 140.

In various implementations, physical processor(s) 112 may be configured to provide information processing capabilities in system 100. As such, the processor(s) 112 may comprise one or more of a digital processor, an analog processor, a digital circuit designed to process information, a central processing unit, a graphics processing unit, a microcontroller, a microprocessor, a field programmable gate array (FPGA), an application specific integrated circuit (ASIC), a System on a Chip (SoC), and/or other mechanisms for electronically processing information. Processor(s) 112 may be configured to execute one or more computer readable instructions 114. Computer readable instructions 114 may include one or more computer program components. In various implementations, computer readable instructions 114 may include one or more of map conversion component 116, image quantization component 118, image compression component 120, image transfer component 122, image decompression component 124, image conversion component 126, and/or other computer program components. As used herein, for convenience, the various computer readable instructions 114 will be described as performing an operation, when, in fact, the various instructions program the processor(s) 112 (and therefore system 100) to perform the operation.

In various implementations, map conversion component 116 may be configured to apply a conversion to an image. For example, map conversion component 116 may be configured to apply an integrating conversion or a color-space conversion to an image. In various implementations, the image may comprise a normal map (e.g., represented as an RGB image) or any other type of texture/map, including other physical based rendering (PBR) maps such as a base color map, a metal map, a roughness map, an emissive map, an ambient occlusion map, a diffuse map, a specular map, and/or one or more other similar types of maps now known or future developed. In various implementations, the image may comprise a normal map in BMP format, PNG format, or any other suitable format. In some implementations, the image may comprise more than one map (e.g., encoded in different color channels). For example, the image may comprise a metal map, a roughness map, and an ambient occlusion map each represented by a different color channel in the same color image. In some implementations, the image may comprise one or more PBR maps.

In various implementations, map conversion component 116 may be configured to apply an integrating conversion to an image, which produces an “integrated image.” Each of the pixels in the image may be represented in the integrated image as floating-point numbers. As described herein, map conversion component 116 may be configured to use one of various integrating conversions to produce the integrated image.

In some implementations, map conversion component 116 may be configured to apply an integrating conversion that assigns an integrated value (or “integrated(0,0)”) to the (0,0) point in the “integrated” image. For example, the integrated value assigned to the (0,0) point may be “0.” This conversion may then take a projection of the normal vector in the normal's map point (0,0) to the (Y,Z) plane and determine a slope of this projection. This slope (which may also be referred to herein as “dz/dy”) may then be applied to determine a value of the integrated image in point (0,1). For example, this slope may be added to the integrated value assigned to the (0,0) to produce the integrated value assigned to the (0,1) point (i.e., “integrated(0,1)=integrated(0,0)+dz/dy”) These steps may be repeated for all the points in the line which can be described as (0,y). A similar process can be used to calculate values for the points in the line which can be described as (x,0) (i.e., “integrated(x,0)”). For example, a projection may be taken to the (X,Z) plane and the slope of the projection (which may also be referred to herein as “dx/dz”) may be used to determine integrated(x,0). Then, for each point (x,y), which has integrated(x−1,y) and integrated(x,y−1) already calculated, the conversion may take a projection of the normal vector in the normal's map point (x,y) to the X-axis and determine a slopeX of this projection, and take a projection of the normal vector in the normal's map point (x,y) to the Y-axis and determine a slopeY of this projection. With this, the conversion may calculate “integrated(x,y)=(slopeX+integrated(x−1,y)+slope Y+integrated(x,y−1))/2.” These steps may be repeated until an integrated value is calculated for each remaining point in the image (i.e., until integrated(x,y) is calculated for all the valid values of (x,y)).

In some implementations, map conversion component 116 may be configured to apply an integrating conversion that is configured to optimize per-pixel difference between an original normal map and a normal map obtained when a pre-defined “differential operator” is applied to that point. For example, this integrating conversion may first assign all floating-point “pixels” in an image the same value (e.g., 0). This conversion may then go over the floating-point pixels in the image and try to change them so that when a pre-defined differential operator is applied to this pixel and surrounding pixels, the output of the differential operator corresponds to the pixels in the original normal map in the best way. In some implementations, the output may be optimized by using standard numerical methods for finding a maximum of a function (e.g., using golden-section search, gradient descent, and/or other similar methods). In some implementations, map conversion component 116 may be configured to calculate the differential operator based on a current point and two adjacent points (one adjacent point in the x-direction and one adjacent point in the y-direction). For example, a differential operator may be defined as “slopeXcalc(x, y)=integrated(x,y)−integrated(x−1,y)” and “slopeYcalc(x, y)=integrated(x,y)−integrated(x,y−1).” In this case, the conversion may find a value of integrated(x,y) minimizing the quantity “(slopeXcalc(x,y)−dX(x,y))²+(slopeYcalc(x,y)−dY(x,y))².” Such a value of integrated(x,y) can be calculated as (integrated(x−1,y)+integrated(x+1,y)+integrated(x,y−1)+integrated(x,y+1)−dX(x+1,y)+dX(x−1,y)−dY(x,y+1)+dY(x,y−1))/4.” These steps may be repeated for each of the pixels numerous times (e.g., 100-1000 times). In some embodiments, the next pixel to process may be chosen in a pseudo-random manner.

In various implementations, map conversion component 116 may be configured to apply a color space conversion to each pixel of an image, which produces a “color-converted image.” Color space conversion refers to a conversion from one color space (e.g., RGB) to another color space (e.g., HSV, YCbCr, LMS, or XYB). In various implementations, the color space conversion may include multiplication of RGB values of the pixel to a 3×3 “color conversion” matrix, gamma correction, and/or one or more other processes.

In some implementations in which an integrating conversion is applied to produce an integrated image, map conversion component 116 may be configured to also apply a color space conversion after applying the integrating conversion. For example, map conversion component 116 may be configured to apply a color space conversion to the integrated image prior to quantization being applied to the integrated image, as described herein with respect to image quantization component 118. In some implementations, map conversion component 116 may be configured to apply multiple different pre-defined color space conversions before one is chosen. In various implementations, map conversion component 116 may be configured chose a pre-defined color space conversion to apply in order to “optimize” a certain metric, as described further herein.

In various implementations, image quantization component 118 may be configured to apply quantization to the image. For example, image quantization component 118 may be configured to apply quantization to an integrated image produced by applying an integrating conversion to the image or to a color-converted image produced by applying a color space conversion to the image.

In various implementations, image quantization component 118 may be configured to apply quantization to a floating-point integrated image in order to obtain an RGB integrated image. For example, image quantization component 118 may be configured to find minimum and maximum values for the floating points within the integrated image, and calculate “scale=maximum_value−minimum_value.” Value 0 may then correspond to the minimum_value, and value 255 may correspond to the maximum_value, with intermediate numbers representing a linear approximation between 0 and 255 (for example, “X=(floating_point_pixel-minimum_value)/scale*256)”). Then, for each pixel, image quantization component 118 may be configured to calculate approximate value X to create a greyscale pixel with “R=G=B=X.” In implementations in which an RGB representation with more than 8-bit encodings is used (such as 10-bit or 12-bit encodings supported by AVIF), “2\hat{ } number_of_bits-1” may be used to represent maximum values. In some implementations, image quantization component 118 may be configured to create a map of the values to be used during decoding (i.e., a “value map”). For example, all the values may be sorted and split into 256 (or, more generally, “2\hat{ }number_of_bits”) buckets, and then for each bucket, image quantization component 118 may be configured to assign all the pixels in the bucket a value of the bucket number, calculate an average of each bucket, and add to the value map a pair (i.e., “number of bucket, calculated average value”), which may be denoted as “map[number_of_bucket]=calculated_average_value.” After quantization, the resultant map may correspond to an approximation of a “height map.” In implementations in which the original image is a normal map, the height map may correspond to a map that was used to create the normal map.

In some implementations, image quantization component 118 may be configured to perform quantization by simple multiplication by “2\hat{ }number_of_bits” (which may, for example, equal 256) with subsequent rounding. For example, in implementations in which the original image is a PBR map, image quantization component 118 may be configured to perform quantization by simple multiplication by 256 with subsequent rounding and/or using the other quantization techniques described herein.

In various implementations, image compression component 120 may be configured to compress the image. For example, image compression component 120 may be configured to compress an integrated image or a color-converted image using an existing compression method. In various implementations, image compression component 120 may be configured to compress the RGB integrated image produced by applying quantization to the floating-point integrated image. In some implementations, image compression component 120 may be configured to apply one or more existing lossy compression methods to the image, such as the lossy compression methods used for the AVIF, WebP, HEIC, or WebP2 file formats or the lossy compression methods used for the JPEG family of file formats (e.g., JPEG, JPEG 2000, JPEG XR, and JPEG XL). In some implementations, image compression component 120 may be configured to apply one or more existing lossless compression methods to the image, such as the lossless compression methods used for the PNG, WebP, or WebP2 file formats or the lossless compression methods used for the JPEG family of file formats. These and other compression methods now known or future developed may be used with the systems and methods described herein.

In various implementations, image transfer component 122 may be configured to transfer and/or store a compressed image. For example, image transfer component 122 may be configured to transfer and/or store a compressed integrated image or a compressed color-converted image. In various implementations, image transfer component 122 may be configured to transfer the compressed image to, from, and/or between components of system 100. For example, image transfer component 122 may be configured to transfer the compressed image over the Internet, an intranet, a PAN (Personal Area Network), a LAN (Local Area Network), a WAN (Wide Area Network), a wireless network, a cellular communications network, a Public Switched Telephone Network, and/or other network. In various implementations, image transfer component 122 may be configured to store the compressed image in electronic storage 130 and/or in one or more other storage devices the same as or similar to electronic storage 130 that are associated with or accessible by system 100. For example, in some implementations, image transfer component 122 may be configured to store a compressed image on a hard drive or in other magnetically readable storage media, on a solid-state drive (SSD) or in other solid-state storage media, and/or in one or more other types of electronic storage devices described herein. In some implementations, image transfer component 122 may be configured to also transfer and/or store additional information associated with an image, such as a scale, a value map, a color conversion matrix that was used, an identifier indicating a color space conversion schema that was used, a gamma correction that was used, and/or other information associated with an image.

In various implementations, image decompression component 124 may be configured to decompress the compressed image. For example, image decompression component 124 may be configured to decompress the compressed integrated image or the compressed color-converted image. In various implementations, image decompression component 124 may be configured to decompress the compressed image using an existing decompression method. For example, image decompression component 124 may be configured to decompress the compressed image with a decompression method that is complimentary to the compression method used to compress the image.

In various implementations, image conversion component 126 may be configured to convert the decompressed image back to the original image. For example, image conversion component 126 may be configured to convert decompressed integrated image or the decompressed color-converted image back into their respective original images.

In various implementations, image conversion component 126 may be configured to convert a decompressed integrated image back into the original image. For example, in implementations in which the original image comprised a normal map or other image to which an integrating conversion was applied to produce the integrated image, image conversion component 126 may be configured to convert the decompressed integrated image into a floating-point representation. In various implementations, image conversion component 126 may be configured to multiply each point in the normal map by a scale parameter. For example, image conversion component 126 may be configured to multiply each point in the normal map by the scale parameter calculated during quantization. In various implementations, image conversion component 126 may be configured to assign each pixel in the decompressed integrated image with a value taken from the value map.

In some implementations, image conversion component 126 may be configured to apply a differential conversion to the image (or the floating-point representation of the image). In particular, image conversion component 126 may be configured to apply a differential conversion to the image (or the floating-point representation of the image) where an integrating conversion was applied during compression. In various implementations, differential conversion may revert integrating conversion made during compression. For example, in some implementations, shift may be removed. In some implementations, shift may be removed by encoding the value of the constant shift and subtracting it during decoding. Various techniques may be used to apply a differential conversion. In some implementations, image conversion component 126 may be configured to apply a differential conversion defined by “slopeXcalc(x,y)=integrated(x,y)−integrated(x−1,y)” and “slopeYcalc(x, y)=integrated(x,y)−integrated(x,y−1).” In some implementations, image conversion component 126 may be configured to apply a Sobel operator, a Scharr operator, and/or a Laplacian operator to the image. For example, image conversion component 126 may be configured to apply a Sobel operator, a Scharr operator, a Prewitt operator, a Canny operator, and/or a Laplacian operator to the image; for example, Sobel operator, Prewitt operator, Canny operator, and Laplacian operator are described in “Comparing Edge Detection Methods” by Nika Tsankashvili, which can be found at https://web.archive.org/web/20231116080234/https://medium.com/@nikatsanka/comparing-edge-detection-methods-638a2919476e, the entirety of which is herein incorporated by reference. In various implementations, the image obtained after converting the image into a floating-point representation and/or applying a differential conversion to the image may comprise the decompressed normal map to which an integrating conversion was originally applied by map conversion component 116, as described herein.

In various implementations, image conversion component 126 may be configured to convert a decompressed color-converted image back into the original image. For example, in implementations in which the original image comprised a PBR map or other image to which a color space conversion was applied to each pixel of the image to produce the color-converted image, image conversion component 126 may be configured to perform inverse color space conversion on the decompressed color-converted image. In various implementations, performing the inverse color space conversion may include reverse gamma conversion and/or multiplication of RGB values to inverse of color conversion matrix described herein. For example, image conversion component 126 may be configured to obtain the color conversion matrix from stored and/or transferred information or obtain a color conversion matrix that has been embedded into a decoder. In various implementations, the image obtained after performing an inverse color space conversion of the decompressed color-converted image may comprise the decompressed PBR map to which a color space conversion was originally applied by map conversion component 116, as described herein.

As described herein, in some implementations, a color space conversion may be applied to an integrated image prior to quantization being applied to the integrated image. After such a compressed integrated image is decompressed, image conversion component 126 may be configured to apply an inverse color space conversion to the decompressed integrated image after converting the integrated image to a floating-point representation of the image, but before a differential conversion is applied. In some implementations, image conversion component 126 may be configured to determine which inverse color space conversion to apply to a decompressed integrated image based on additional information transferred and/or stored in association with the image that indicates which color space conversion was applied to the integrated image.

Electronic storage 130 may include electronic storage media that electronically stores and/or transmits information. The electronic storage media of electronic storage 130 may be provided integrally (i.e., substantially nonremovable) with one or more components of system 100 and/or removable storage that is connectable to one or more components of system 100 via, for example, a port (e.g., USB port, a Firewire port, and/or other port) or a drive (e.g., a disk drive and/or other drive). Electronic storage 130 may include one or more of optically readable storage media (e.g., optical disks and/or other optically readable storage media), magnetically readable storage media (e.g., magnetic tape, magnetic hard drive, floppy drive, and/or other magnetically readable storage media), electrical charge-based storage media (e.g., EPROM, EEPROM, RAM, and/or other electrical charge-based storage media), solid-state storage media (e.g., flash drive and/or other solid-state storage media), and/or other electronically readable storage media. Electronic storage 130 may be a separate component within system 100, or electronic storage 130 may be provided integrally with one or more other components of system 100 (e.g., computer system 110 or processor 112). Although electronic storage 130 is shown in FIG. 1 as a single entity, this is for illustrative purposes only. In some implementations, electronic storage 130 may comprise a plurality of storage units. These storage units may be physically located within the same device, or electronic storage 130 may represent storage functionality of a plurality of devices operating in coordination.

Electronic storage 130 may store software algorithms, information determined by processor 112, information received remotely, and/or other information that enables system 100 to function properly. For example, electronic storage 130 may store information relating to one or more three-dimensional models, one or more textures, one or more existing compression methods (i.e., one or more existing compression algorithms) to be used to compress an image or texture, one or more existing decompression methods (i.e., one or more existing compression algorithms) to be used to decompress a compressed image or texture, compressed image themselves (such as a compressed integrated image or a compressed color-converted image), additional information associated with an image (such as a scale, a value map, a color conversion matrix that was used, a gamma correction that was used, and/or other information associated with an image), and/or other information related to the systems and methods described herein.

Client computing device(s) 140 (also interchangeably referred to herein as client computing device 140, client computing devices 140, or one or more client computing devices 140) may be used by users of system 100 to interface with system 100. Client computing device(s) 140 may be configured as a server device (e.g., having one or more server blades, processors, etc.), a gaming console, a handheld gaming device, a personal computer (e.g., a desktop computer, a laptop computer, etc.), a smartphone, a tablet computing device, an Internet of Things (IoT) device, a wearable device, and/or other device that can be programmed to interface with computer system 110.

In various implementations, system 100 may include one or more user interface devices 150 connected to one or more components of system 100 via interface 102 to facilitate user interaction. For example, user interface device(s) 150 may include a monitor and/or other devices configured to display or otherwise provide information to the user. In various implementations, user interface device(s) 150 may include a keyboard, a pointing device such as a mouse or a trackball, and/or one or more other input devices to enable a user to provide input to computer system 110, electronic storage 130, and/or client computing devices 140 via interface 102.

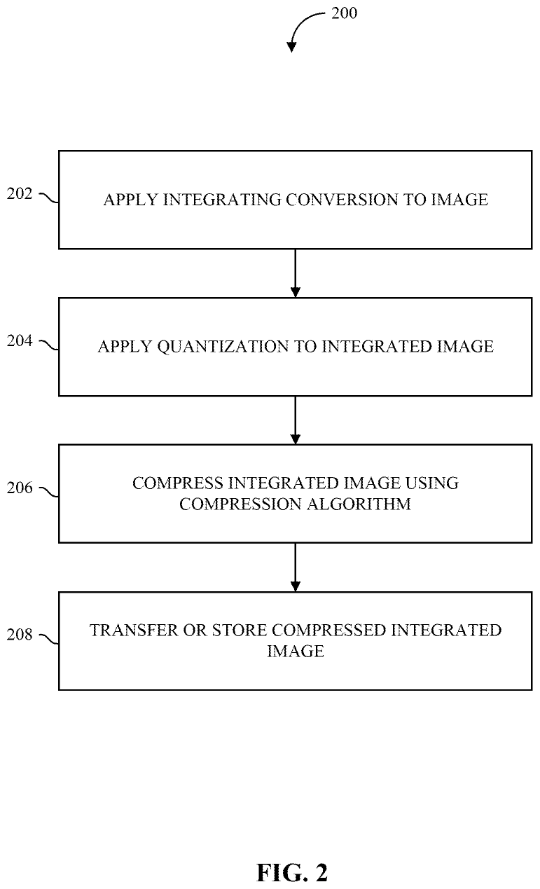

FIG. 2 illustrates an example of a process 200 for compressing texture maps using an integrating conversion, according to one or more aspects described herein. The operations of process 200 presented below are intended to be illustrative and, as such, should not be viewed as limiting. In some implementations, process 200 may be accomplished with one or more additional operations not described, and/or without one or more of the operations discussed. In some implementations, two or more of the operations of process 200 may occur substantially simultaneously. The described operations may be accomplished using some or all of the system components described in detail above.

In an operation 202, process 200 may include applying an integrating conversion to an image. In various implementations, the image may comprise a normal map (e.g., represented as an RGB image) or any other type of texture/map. In various implementations, the image may comprise a normal map in BMP format, PNG format, or any other suitable format. Applying an integrating conversion to the image may produce an “integrated image,” in which each of the pixels in the image may be represented as floating-point numbers. In some implementations, the integrating conversion may involve optimizing per-pixel difference between an original normal map and a normal map obtained when a pre-defined “differential operator” is applied to this point. In some implementations, the differential operator may be calculated based on a current point and two adjacent points (one adjacent point in the x-direction and one adjacent point in the y-direction). As described herein, various integrating conversions may be used to produce the integrated image. In some implementations, a color space conversion may also be applied to the integrated image prior to operation 204. In some implementations, operation 202 may be performed by a processor component the same as or similar to map conversion component 116 (shown in FIG. 1 and described herein).

In some implementations, an integrating conversion may be applied in operation 202 that begins by assigning a certain value integrated(0,0) (e.g., 0) to the (0,0) point in the “integrated” image, as described herein. This conversion may then proceed by taking a projection of the normal vector in the normal's map point (0,0) to the (Y,Z) plane and determining a slope of this projection (dz/dy). This slope (dz/dy) may then be applied to determine a value of the integrated image in point (0,1): “integrated(0,1)=integrated(0,0)+dz/dy.” These steps may be repeated for all the points in the line which can be described as (0,y). A similar process can be used to calculate values for integrated(x,0), in which the projection is taken to the (X,Z) plane and the slope of the projection (dx/dz) is used to determine integrated(x,0). Then, for each point (x,y) which has integrated(x−1,y) and integrated(x,y−1) already calculated, this conversion may proceed by taking a projection of the normal vector in the normal's map point (x,y) to the X-axis and determining a slopeX of this projection, and taking a projection of the normal vector in the normal's map point (x,y) to the Y-axis and determining a slopeY of this projection. With this, the following may be calculated: “integrated(x,y)=(slopeX+integrated(x−1,y)+slope Y+integrated(x,y−1))/2.” These steps may be repeated until integrated(x,y) is calculated for all the valid values of (x,y).

In other implementations, an integrating conversion may be applied in operation 202 that begins by assigning all floating-point “pixels” in an image the same value (e.g., 0), as described herein. This conversion may then proceed by going over the floating-point pixels in the image and try to change them so that when a pre-defined differential operator is applied to this pixel and surrounding pixels, the output of the differential operator corresponds to the pixels in the original normal map in the best way. In some embodiments, the output may be optimized by using standard numerical methods for finding a maximum of a function (e.g., using golden-section search, gradient descent, and/or other similar methods). In some embodiments, a differential operator may be defined as “slopeXcalc(x, y)=integrated(x,y)−integrated(x−1,y)” and “slopeYcalc(x, y)=integrated(x,y)−integrated(x,y−1).” In this case, it may be required to find a value of integrated(x,y) minimizing the quantity “(slopeXcalc(x,y)−dX(x,y))²+(slope Ycalc(x,y)−dY(x,y))².” Such a value of integrated(x,y) can be calculated as (integrated(x−1,y)+integrated(x+1,y)+integrated(x,y−1)+integrated(x,y+1)−dX(x+1,y)+dX(x−1,y)−dY(x,y+1)+dY(x,y−1))/4.” These steps may be repeated for each of the pixels numerous times (e.g., 100-1000 times). In some embodiments, the next pixel to process may be chosen in a pseudo-random manner.

In an operation 204, process 200 may include applying quantization to the integrated image. For example, quantization may be performed on the integrated image produced by applying an integrating conversion to the image in operation 202. Applying quantization on the floating-point integrated image may produce an RGB integrated image. In various implementations, applying quantization to the integrated image may include finding minimum and maximum values for the floating points within the integrated image and using those values to calculate “scale=maximum_value−minimum_value.” Value 0 may correspond to the minimum_value, and value 255 may correspond to the maximum_value, with intermediate numbers representing a linear approximation between 0 and 255 (for example, “X=(floating_point_pixel−minimum_value)/scale*256)”). Then, for each pixel, approximate value X may be calculated to create a greyscale pixel with “R=G=B=X.” In implementations in which an RGB representation with more than 8-bit encodings is used (such as 10-bit or 12-bit encodings supported by AVIF), “2\hat{ }number_of_bits-1” may be used to represent maximum values. In some implementations, a map of the values to be used during decoding (i.e., a “value map”) may be created. For example, all the values may be sorted and split into 256 (or, more generally, “2\hat{ }number_of_bits”) buckets, and then for each bucket, all the pixels in the bucket may be assigned the value of the bucket number, an average of each bucket may be calculated, and a resultant pair (i.e., “number of bucket, calculated average value”) may be added to the value map, which may be denoted as “map[number_of_bucket]=calculated_average_value.” After quantization, the resultant map may correspond to an approximation of a “height map.” In implementations in which the original image is a normal map, the height map may correspond to a map that was used to create the normal map. In some implementations, operation 204 may be performed by a processor component the same as or similar to image quantization component 118 (shown in FIG. 1 and described herein).

In an operation 206, process 200 may include compressing the integrated image using a compression method. In various implementations, the integrated image may be compressed using an existing compression method. In various implementations, the integrated image that is compressed is the RGB integrated image produced by applying quantization to the floating-point integrated image. In some implementations, the integrated image may be compressed by applying one or more existing lossy compression methods, such as the lossy compression methods used for the AVIF, WebP, HEIC, or WebP2 file formats or the lossy compression methods used for the JPEG family of file formats (e.g., JPEG, JPEG 2000, JPEG XR, and JPEG XL). In some implementations, the integrated image may be compressed by applying one or more existing lossless compression methods to the image, such as the lossless compression methods used for the PNG, WebP, or WebP2 file formats or the lossless compression methods used for the JPEG family of file formats. In some implementations, operation 206 may be performed by a processor component the same as or similar to image compression component 120 (shown in FIG. 1 and described herein).

In an operation 208, process 200 may include transferring or storing the compressed integrated image. The compressed integrated image may be transferred to, from, and/or between components of the system described herein. For example, the compressed image may be transferred over the Internet, an intranet, a PAN (Personal Area Network), a LAN (Local Area Network), a WAN (Wide Area Network), a wireless network, a cellular communications network, a Public Switched Telephone Network, and/or other network. In various implementations, the compressed integrated image may be stored in electronic storage and/or in one or more other storage devices associated with or accessible by the system described herein. For example, in some implementations, the compressed integrated image may be stored on a hard drive or in other magnetically readable storage media, on a solid-state drive (SSD) or in other solid-state storage media, and/or in one or more other types of electronic storage devices described herein. In some implementations, additional information associated with an image may be transferred and/or stored. For example, the additional information may include a scale, a value map, and/or other information associated with an image. In some implementations, operation 208 may be performed by a processor component the same as or similar to image transfer component 122 (shown in FIG. 1 and described herein).

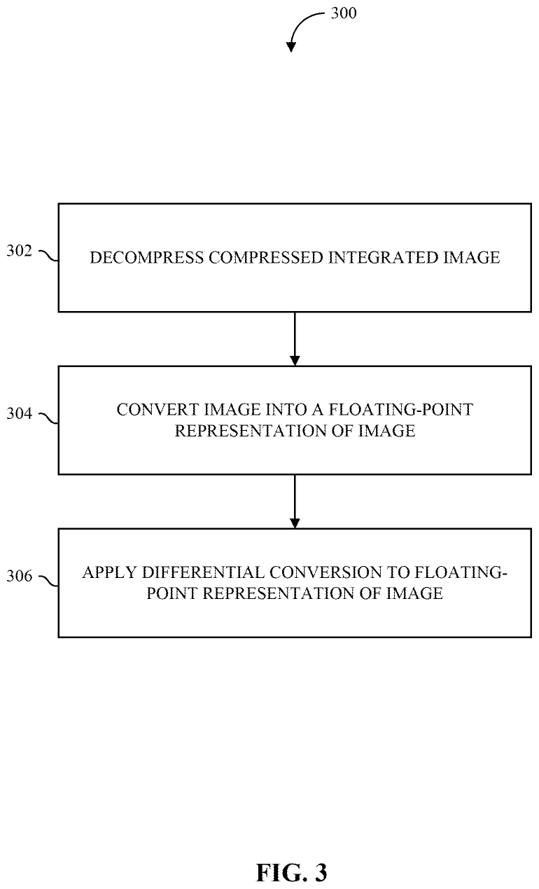

FIG. 3 illustrates an example of a process 300 for decompressing integrated images using differential conversion, according to one or more aspects described herein. The operations of process 300 presented below are intended to be illustrative and, as such, should not be viewed as limiting. In some implementations, process 300 may be accomplished with one or more additional operations not described, and/or without one or more of the operations discussed. In some implementations, two or more of the operations of process 300 may occur substantially simultaneously. The described operations may be accomplished using some or all of the system components described in detail above.

In an operation 302, process 300 may include decompressing a compressed integrated image. In various implementations, the compressed integrated image may be decompressed using an existing decompression method. For example, the compressed integrated image may be decompressed with a decompression method that is complimentary to the compression method used to compress the integrated image. In some implementations, the compressed integrated image that is decompressed is a compressed RGB integrated image. In some implementations, operation 302 may be performed by a processor component the same as or similar to image decompression component 124 (shown in FIG. 1 and described herein).

In an operation 304, process 300 may include converting the decompressed image into a floating-point representation of the image. In implementations in which the original image comprised a normal map or other image to which an integrating conversion was applied, for example, in operation 202 to produce the integrated image, the decompressed integrated image may be converted into a floating-point representation. Converting the decompressed image into a floating-point representation may comprise multiplying each point in the normal map by a scale parameter. In some implementations, each pixel may then be assigned a value taken from the value map. In some implementations (e.g., in implementations in which a color space conversion is also applied to an integrated image prior to quantization), an inverse color space conversion may also be applied to the decompressed integrated image after converting the decompressed integrated image to a floating-point representation of the image but before operation 306. In some implementations, operation 304 may be performed by a processor component the same as or similar to image conversion component 126 (shown in FIG. 1 and described herein).

In an operation 306, process 300 may include applying a differential conversion to the floating-point representation of the image. More particularly, when an integrating conversion is applied during compression, a differential conversion may be applied to the floating-point representation of the image during decompression. Various techniques may be used to apply a differential conversion. In some implementations, a differential conversion may be applied that is defined by “slopeXcalc(x,y)=integrated(x,y)−integrated(x−1,y)” and “slopeYcalc(x, y)=integrated(x,y)−integrated(x,y−1).” In some implementations, a Sobel operator, a Scharr operator, and/or a Laplacian operator may be applied to the image. In various implementations, the image obtained after converting the image into a floating-point representation and/or applying a differential conversion to the image may comprise the decompressed normal map to which an integrating conversion was originally applied, for example, in operation 202. In some implementations, operation 306 may be performed by a processor component the same as or similar to image conversion component 126 (shown in FIG. 1 and described herein).

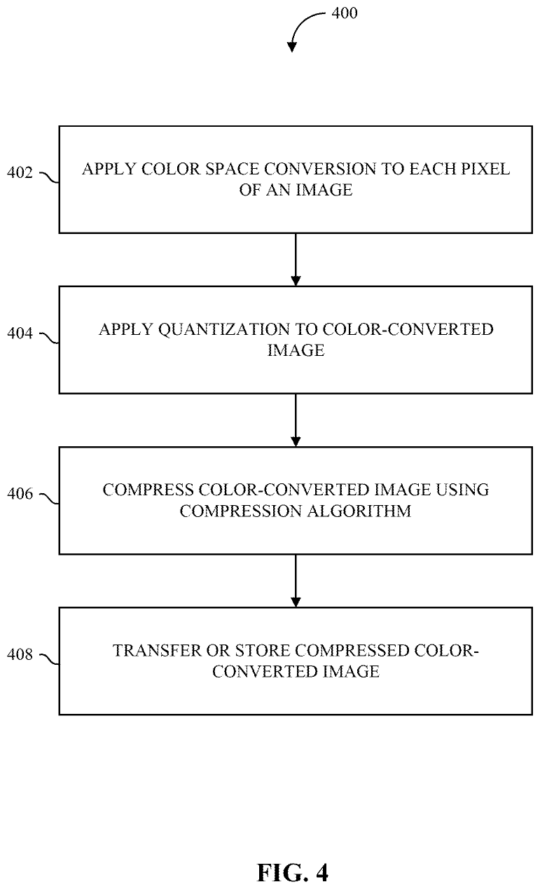

FIG. 4 illustrates an example of a process 400 for compressing texture maps using a color space conversion, according to one or more aspects described herein. The operations of process 400 presented below are intended to be illustrative and, as such, should not be viewed as limiting. In some implementations, process 400 may be accomplished with one or more additional operations not described, and/or without one or more of the operations discussed. In some implementations, two or more of the operations of process 400 may occur substantially simultaneously. The described operations may be accomplished using some or all of the system components described in detail above.

In an operation 402, process 400 may include applying a color space conversion to an image. In various implementations, the image may comprise a normal map (e.g., represented as an RGB image) or any other type of texture/map. For example, the image may comprise a PBR map such as a base color map, a metal map, a roughness map, an emissive map, an ambient occlusion map, a diffuse map, a specular map, and/or one or more other similar types of maps. In some implementations, the image may comprise more than one map (e.g., encoded in different color channels). For example, the image may comprise a metal map, a roughness map, and an ambient occlusion map each represented by a different color channel in the same color image. In various implementations, a color space conversion may be applied to each pixel of the image, which may produce a “color-converted image.” In some implementations, the image may comprise one or more PBR maps. The color space conversion may include multiplication of RGB values of the pixel to a 3×3 “color conversion” matrix, gamma correction, and/or one or more other processes. In some implementations, operation 402 may be performed by a processor component the same as or similar to map conversion component 116 (shown in FIG. 1 and described herein).

In an operation 404, process 400 may include applying quantization to the color-converted image. For example, quantization may be performed on the color-converted image produced by applying a color space conversion to the image in operation 402. In some implementations, quantization may be performed by simple multiplication by “2\hat{ }number_of_bits” (which may, for example, equal 256) with subsequent rounding and/or using one or more other quantization techniques described herein (e.g., as described herein with respect to operation 204). In some implementations, operation 404 may be performed by a processor component the same as or similar to image quantization component 118 (shown in FIG. 1 and described herein).

In an operation 406, process 400 may include compressing the color-converted image using a compression method. In various implementations, the color-converted image may be compressed using an existing compression method. In some implementations, the color-converted image may be compressed by applying one or more existing lossy compression methods, such as the lossy compression methods used for the AVIF, WebP, HEIC, or WebP2 file formats or the lossy compression methods used for the JPEG family of file formats (e.g., JPEG, JPEG 2000, JPEG XR, and JPEG XL). In some implementations, the color-converted image may be compressed by applying one or more existing lossless compression methods to the image, such as the lossless compression methods used for the PNG, WebP, or WebP2 file formats or the lossless compression methods used for the JPEG family of file formats. In various implementations, the color-converted image may be quantized before compression. In some implementations, operation 406 may be performed by a processor component the same as or similar to image compression component 120 (shown in FIG. 1 and described herein).

In an operation 408, process 400 may include transferring or storing the compressed color-converted image. The compressed color-converted image may be transferred to, from, and/or between components of the system described herein. For example, the compressed image may be transferred over the Internet. In various implementations, the compressed color-converted image may be stored in electronic storage and/or in one or more other storage devices associated with or accessible by the system described herein. For example, in some implementations, the compressed color-converted image may be stored on a solid-state drive (SSD) or in other solid-state storage media. In some implementations, additional information associated with an image may be transferred and/or stored. For example, the additional information may include a color conversion matrix that was used, a gamma correction that was used, and/or other information associated with an image. In some implementations, operation 408 may be performed by a processor component the same as or similar to image transfer component 122 (shown in FIG. 1 and described herein).

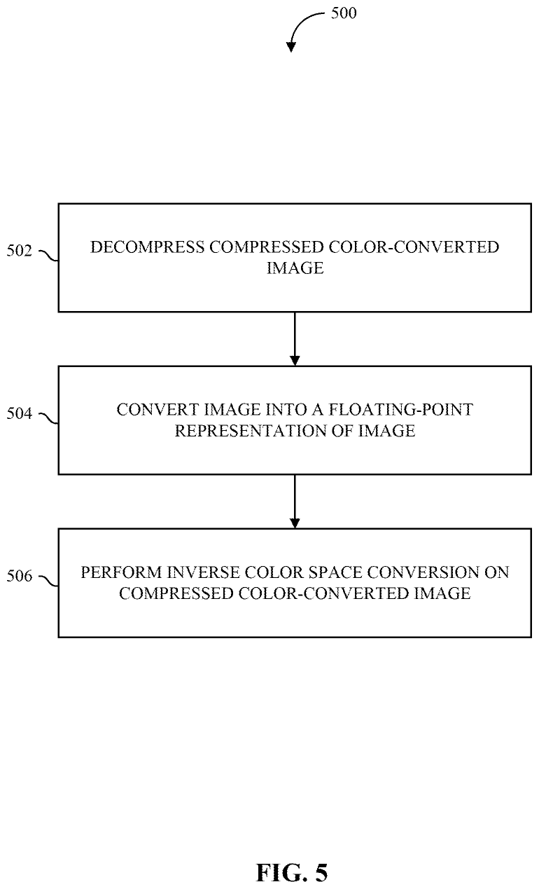

FIG. 5 illustrates an example of a process 500 for decompressing color-converted images using inverse color space conversion, according to one or more aspects described herein. The operations of process 500 presented below are intended to be illustrative and, as such, should not be viewed as limiting. In some implementations, process 500 may be accomplished with one or more additional operations not described, and/or without one or more of the operations discussed. In some implementations, two or more of the operations of process 500 may occur substantially simultaneously. The described operations may be accomplished using some or all of the system components described in detail above.

In an operation 502, process 500 may include decompressing a compressed color-converted image. In various implementations, the compressed color-converted image may be decompressed using an existing decompression method. For example, the compressed color-converted image may be decompressed with a decompression method that is complimentary to the compression method used to compress the color-converted image. In some implementations, operation 502 may be performed by a processor component the same as or similar to image decompression component 124 (shown in FIG. 1 and described herein).

In an operation 504, process 500 may include converting the decompressed image into a floating-point representation of the image. In implementations in which the original image comprised a normal map or other image to which an integrating conversion was applied, for example, in operation 202 to produce the integrated image, the decompressed integrated image may be converted into a floating-point representation. Converting the decompressed image into a floating-point representation may comprise multiplying each point in the normal map by a scale parameter. In some embodiments, each pixel may then be assigned a value taken from the value map. In some implementations (e.g., in implementations in which a color space conversion is also applied to an integrated image prior to quantization), an inverse color space conversion may also be applied to the decompressed integrated image after converting the decompressed integrated image to a floating-point representation of the image but before operation 506. In some implementations, operation 504 may be performed by a processor component the same as or similar to image conversion component 126 (shown in FIG. 1 and described herein).

In an operation 506, process 500 may include performing an inverse color space conversion of the decompressed color-converted image. In implementations in which the original image comprised a PBR map or other image to which a color space conversion was applied, for example, in operation 402 to each pixel of the image to produce the color-converted image, an inverse color space conversion may be performed on the decompressed color-converted image. In various implementations, performing the inverse color space conversion may include reverse gamma conversion and/or multiplication of RGB values to inverse of color conversion matrix described herein. For example, the color conversion matrix may be obtained from stored and/or transferred information or from a decoder in which it is embedded. In various implementations, the image obtained after performing an inverse color space conversion of the decompressed color-converted image may comprise a decompressed PBR map to which a color space conversion was originally applied, for example, in operation 402. In some implementations, operation 506 may be performed by a processor component the same as or similar to image conversion component 126 (shown in FIG. 1 and described herein).

In some embodiments, processes 400 and 500 may further include permutation of color channels before compression and reverse permutation after compression. For example, some existing image compression (and decompression) methods may not be symmetrical with regards to color channels. Thus, to improve compression, certain color channels may be swapped before compression and swapped back after decompression. For example, blue and green color channels may be swapped during compression and swapped back after decompression to improve compression.

In some implementations, a pre-defined color conversion to apply to an image may be chosen in order to “optimize” a certain metric. The metric to be optimized may be, for example, compressed size of the image, or its “quality” (which may be measured, for example, using, peak signal-to-noise ratio (PSNR), structural similarity index measure (SSIM), and/or one or more other compressed image quality metrics), or any function (including linear function) of these. In some embodiments, a certain metric may be optimized by using one or more optimization methods (e.g., using gradient descent), using matrix coefficients or gamma correction parameters as variables to be optimized. In such cases, these optimized parameters may be transferred and/or stored alongside the compressed image (e.g., as “additional information”). In some implementations, normalization of the normal vectors may be relied upon and the normal vectors may be converted to a form in which they contain only two variables. Then, only two components may be filled in two respective RGB channels, leaving a third component to be filled in a way which is the most optimal for the compressor. In some embodiments, the technique that may be the most optimal is to fill the third component with constant color. In some embodiments, one color channel (e.g., the blue channel) may simply be ignored, filling it with a certain value (such as a maximum value, often 255) during decoding.

In some embodiments, pixel data may be used to ignore one of the color components. For example, some existing rendering engines may ignore blue color while processing a normal map. In such implementations, a color space conversion may be selected (for the techniques described here) such that, for each two remaining (non-ignored) components, the result of conversion is such that one of the components in the target space is always the same. For example, when transforming RGB color space to YUV color space, it may be desirable to set the Y component to some fixed value to achieve lower compression size.

In an exemplary implementation, the source color space may be RGB, and the target space may be YUV. A blue component of any pixel value in the source space may be ignored, and it may be desirable to set the y-component in the target space to some predefined value Y. In one such implementation, a conversion may be given by a 3*3 “color conversion” matrix

$$A = \begin{matrix}a 11 & a 12 & a 13 \\ a 21 & a 22 & a 23 \\ a 31 & a 32 & a 33\end{matrix}$$

so that a11=0, a12=0, a13 !=0, a21*a32−a31*a22 !=0, and for each pixel a value of b (blue) component is set to “B=Y/a13” before applying the conversion. It should be noted that such a conversion is invertible, and that, respectively, the value of red and green components could be restored. In another such implementation, any invertible matrix A with “a13 !=0” may be used. In such an implementation, for each pixel with color values (r, g, b) a value of b (blue) component is set to “B=(Y−r*a11−g*a12)/a13” before applying the conversion matrix, thus getting “y=Y” for each pixel (r, g, B). Again, the inverse conversion exists and its matrix is given by the inverse of matrix A. As such, original values of r (red) and g (green) can be restored.

It should be understood that conversions for cases when other (r or g) components in the source space are ignored and/or other components (u or v) in the target space are desired to be a constant can be constructed in a similar way.

In some implementations, it may be desirable to map color values of the original space to values of the target space so that all components in the target space are within certain ranges. For example, while all color values in the RGB space may be within [0, 255] range, it may be desirable to have all their images in YUV space so that their components (y,u,v) are within the same range. In such implementations, an additional (invertible) transformation may be required. Such a transformation may include scaling and adding a constant specific for each component. For example, if it is known that, for a given RGB image after a conversion (r,g,b)->(y,u,v) that values of y, u, v range [Ymin, Ymax], [Umin, Umax], [Vmin, Vmax], respectively, the following additional transformation may be applied: y′=y/(Ymax−Ymin)*255, u′=u/(Umax−Umin)*255, v′=v/(Vmax−Vmin)*255. In some implementations, these Ymin, Ymax, Umin, Umax, Vmin, Vmax values may also be transferred and/or stored alongside the compressed image (e.g., as “additional information”). In other implementations, it may be possible to calculate such values based on the conversion itself. For example, if a conversion is just a multiplication by a matrix, then:

$$Ymin = ( is\_negative ( a 11 ) * a 11 + is\_negative ( a 12 ) * a 12 + is\_negative ( a 13 ) * a 13 ) * 255$$

$$Ymax = ( is\_positive ( a 11 ) * a 11 + is\_positive ( a 12 ) * a 12 + is\_positive ( a 13 ) * a 13 ) * 255$$

$$Umin = ( is\_negative ( a 21 ) * a 21 + is\_negative ( a 22 ) * a 22 + is\_negative ( a 23 ) * a 23 ) * 255$$

$$Umax = ( is\_positive ( a 21 ) * a 21 + is\_positive ( a 22 ) * a 22 + is\_positive ( a 23 ) * a 23 ) * 255$$

$$Vmin = ( is\_negative ( a 31 ) * a 31 + is\_negative ( a 32 ) * a 32 + is\_negative ( a 33 ) * a 33 ) * 255$$

$$Vmax = ( is\_positive ( a 31 ) * a 31 + is\_positive ( a 32 ) * a 32 + is\_positive ( a 33 ) * a 33 ) * 255$$

Where is_negative(x) is −1, if x<0, and 0 otherwise; is_positive(x) is 1, if x>0, and 0 otherwise. In a similar way, such values may be calculated for other conversions described herein. It should be clear, that this approach is not limited to any particular values or ranges.

In some implementations, a normal map may be pre-processed so that all the necessary information is contained in two color channels (for example, it may be done by normalizing normal vector in each pixel so that blue component is always 255). By doing so, it may be assumed that the third channel may be ignored. Then, the conversion described herein for the case of an ignored channel (e.g., the blue channel in the example above) may be used for compression and the inverse may be used for decompression. Also, during decompression, the remaining color channel may be restored. For example, it may be restored by filling blue channel with a fixed value of 255.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

The various illustrative logical blocks, modules, circuits, and method steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application—such as by using any combination of digital processors, analog processors, digital circuits designed to process information, central processing units, graphics processing units, microcontrollers, microprocessors, field programmable gate arrays (FPGAs), application specific integrated circuits (ASICs), a System on a Chip (SoC), and/or other mechanisms for electronically processing information—but such implementation decisions should not be interpreted as causing a departure from the scope of the present invention.

The description of the functionality provided by the different computer-readable instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 112 may be programmed by one or more additional instructions that may perform some or all of the functionality attributed herein to one of the computer-readable instructions.

The various instructions described herein may be stored in electronic storage, which may comprise random access memory (RAM), read only memory (ROM), and/or other memory. In some implementations, the various instructions described herein may be stored in electronic storage of one or more components of system 100 and/or accessible via a network (e.g., via the Internet, cloud storage, and/or one or more other networks). The electronic storage may store the computer program instructions (e.g., the aforementioned instructions) to be executed by processor(s) 112 as well as data that may be manipulated by processor(s) 112. The electronic storage may comprise floppy disks, hard disks, optical disks, tapes, or other storage media for storing computer-executable instructions and/or data.

Although illustrated in FIG. 1 as a single component, computer system 110 and client computing device(s) 140 may each include a plurality of individual components (e.g., computer devices) each programmed with at least some of the functions described herein. In this manner, some components of computer system 110 and/or associated client computing device(s) may perform some functions while other components may perform other functions, as would be appreciated. Furthermore, it should be appreciated that although the various instructions are illustrated in FIG. 1 as being co-located within a single processing unit, in implementations in which processor(s) 112 include multiple processing units, one or more instructions may be executed remotely from the other instructions.

Although processor computer system 110, electronic storage 130, and client computing device(s) 140 are shown to be connected to interface 102 in FIG. 1, any communication medium may be used to facilitate interaction between any components of system 100. One or more components of system 100 may communicate with each other through hard-wired communication, wireless communication, or both. In various implementations, one or more components of system 100 may communicate with each other through a network. For example, computer system 110 may wirelessly communicate with electronic storage 130. By way of non-limiting example, wireless communication may include one or more of radio communication, Bluetooth communication, Wi-Fi communication, cellular communication, infrared communication, or other wireless communication. Other types of communications are contemplated by the present disclosure.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The language used herein has been principally selected for readability and instructional purposes, and it may not have been selected to delineate or circumscribe the inventive subject matter. Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

1. A computer-implemented method of compressing normal maps using an integrating conversion, the method comprising:
applying an integrating conversion to a normal map, wherein applying the integrating conversion to the normal map produces an integrated image of the normal map, wherein each pixel in the integrated image is represented as floating-point numbers; and
compressing the integrated image using a compression method.

2. The computer-implemented method of claim 1, wherein the normal map comprises vectors at each fragment that are normalized in three-dimensional space.

3. The computer-implemented method of claim 1, wherein applying the integrating conversion to the normal map comprises optimizing per-pixel difference between the normal map and a map obtained when a differential operator is applied to each pixel and its surrounding pixels.

4. The computer-implemented method of claim 1, the method further comprising applying quantization to the integrated image, wherein applying quantization to the integrated image produces an RGB integrated image of the normal map, wherein the integrated image compressed using the compression method comprises the RGB integrated image.

5. The computer-implemented method of claim 4, wherein a map obtained after applying quantization to the integrated image corresponds to a height map of the normal map.

6. The computer-implemented method of claim 1, wherein the compression method comprises a compression method associated with the AVIF file format or a method associated with the JPEG XL file format.

7. A system for compressing normal maps using an integrating conversion, the system comprising:
one or more processors configured by computer readable instructions to:
apply an integrating conversion to a normal map, wherein applying the integrating conversion to the normal map produces an integrated image of the normal map, wherein each pixel in the integrated image is represented as floating-point numbers; and
compress the integrated image using a compression method.

8. The system of claim 7, wherein the normal map comprises vectors at each fragment that are normalized in three-dimensional space.

9. The system of claim 7, wherein to apply the integrating conversion to the normal map, the one or more processors are configured to optimize per-pixel difference between the normal map and a map obtained when a differential operator is applied to each pixel and its surrounding pixels.

10. The system of claim 7, wherein the one or more processors are further configured to apply quantization to the integrated image, wherein applying quantization to the integrated image produces an RGB integrated image of the normal map, wherein the integrated image compressed using the compression method comprises the RGB integrated image.

11. The system of claim 10, wherein a map obtained after applying quantization to the integrated image corresponds to a height map of the normal map.

12. The system of claim 7, wherein the compression method comprises a compression method associated with the AVIF file format or a method associated with the JPEG XL file format.

13. A computer-implemented method of improving rendering of three-dimensional models by decompressing texture maps compressed using an integrated conversion, the method comprising:
decompressing a compressed image of a normal map; and
applying a differential conversion to the decompressed image, wherein an image obtained after applying the differential conversion to the decompressed image comprises the normal map.

14. The computer-implemented method of claim 13, wherein the normal map comprises vectors at each fragment that are normalized in three-dimensional space.

15. The computer-implemented method of claim 13, wherein the compressed image is decompressed using a decompression method complimentary to a compression method used to compress the compressed image.

16. The computer-implemented method of claim 13, the method further comprising converting the decompressed image into a floating-point representation of the normal map and applying the differential conversion to the floating-point representation of the normal map, wherein converting the decompressed image into a floating-point representation comprises:
multiplying each point in the normal map by a scale parameter; and
assigning each pixel a value based on a value map generated by applying quantization to an integrated image of the normal map prior to compression.

17. A system for improving rendering of three-dimensional models by decompressing texture maps compressed using an integrated conversion, the system comprising:
one or more processors configured by computer readable instructions to:
decompress a compressed image of a normal map; and
apply a differential conversion to the decompressed image, wherein an image obtained after applying the differential conversion to the decompressed image comprises the normal map.

18. The system of claim 17, wherein the normal map comprises vectors at each fragment that are normalized in three-dimensional space.

19. The system of claim 17, wherein the compressed image is decompressed using a decompression method complimentary to a compression method used to compress the compressed image.

20. The system of claim 17, wherein the one or more processors are further configured to convert the decompressed image into a floating-point representation of the normal map and apply the differential conversion to the floating-point representation of the normal map, wherein to convert the decompressed image into a floating-point representation, the one or more processors are configured to:
multiply each point in the normal map by a scale parameter; and
assign each pixel a value based on a value map generated by applying quantization to an integrated image of the normal map prior to compression.

21-40. (canceled)
